(19) United States
(12) Patent Application Publication
(10) Pub. No.: US 2015/0085746 A1
(43) Pub. Date: Mar. 26, 2015

(54) SELECTIVE UTILIZATION OF CONSUMER SHARED ACCESS POINTS TO FACILITATE OPTIMIZED WIRELESS COMMUNICATIONS

(71) Applicants: Vallabhajosyula Somayazulu, Portland, OR (US); Christian Maciocco, Portland, OR (US); Carlos Cordeiro, Portland, OR (US); Srikathyayani Srikanteswara, Portland, OR (US); Geoff Weaver, Portland, OR (US); Harry Skinner, Beaverton, OR (US)

(72) Inventors: Vallabhajosyula Somayazulu, Portland, OR (US); Christian Maciocco, Portland, OR (US); Carlos Cordeiro, Portland, OR (US); Srikathyayani Srikanteswara, Portland, OR (US); Geoff Weaver, Portland, OR (US); Harry Skinner, Beaverton, OR (US)

(21) Appl. No.: 14/127,777

(22) PCT Filed: Sep. 20, 2013
(86) PCT No.: PCT/US13/60810

§ 371 Date: Dec. 19, 2013

(51) Int. Cl. H04W 48/08

(52) U.S. Cl. CPC H04W 48/08; H04W 4/028
USPC 370/328

(57) ABSTRACT

Certain embodiments herein relate to selective utilization of shared access points to facilitate optimized wireless communications. A wireless access point located at a home, residence, or other facility may be shared among other such access points to form a wireless network of shared access points across various regions or areas. One or more access points that provide an optimized wireless connection for user devices within range of the access points may be determined in certain embodiments herein. The determination may include comparing operational or performance information associated with the access points, such as link quality, quality of service, current load, backhaul connectivity information, etc., as well as pricing associated with the access points, to determine which one or more access points facilitate or provide optimized wireless communications between devices on a wireless network.

### BACKGROUND

Wireless communication may be hindered by a lack of wireless access points in various regions or areas. As a result, wireless devices may not receive timely, reliable communications via a wireless network. Existing wireless communication techniques may not leverage opportunities to share access points that may reside in the various regions with users who may be within range of the access points. Further, existing techniques may not maximize a user's communication experience by evaluating information associated with available access points.

### BRIEF DESCRIPTION OF THE FIGURES

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a schematic diagram of an example system for enabling optimized wireless communication over shared access points, according to an embodiment of the disclosure.

FIG. 2 illustrates an example computing environment tor implementing selective utilization of shared access points, according to an embodiment of the disclosure.

FIG. 3 illustrates a block diagram of an example process for determining an access point for optimized wireless communication via information collected by a cloud computing system, according to an embodiment of the disclosure.

FIG. 4 illustrates a block diagram of an example process for determining an access point for optimized wireless communication via a user device, according to an embodiment of the disclosure.

FIG. 5 illustrates a flow chart of an example process for selective utilization of shared access points to facilitate optimized wireless communications via a cloud computing system, according to an embodiment of the disclosure.

FIG. 6 illustrates a flow chart of an example process for selective utilization of shared access points to facilitate optimized wireless communications via a user device, according to an embodiment of the disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers refer to like elements throughout.

### DETAILED DESCRIPTION

Certain embodiments herein relate to, among other things, selective utilization of shared access points to facilitate optimized wireless communications. A wireless access point located at a home, residence, or other facility may be shared among other such access points to form a wireless network of shared access points across various regions or areas. In one embodiment, each of the access points may be associated with consumers of the access points, who may also be the owners or operators of the access points. Such access points may be shared such that user devices that may be in range of one or more of the access points may utilize the access points to communicate over the wireless network.

Certain embodiments herein relate to determining which one or more access points provide an optimized wireless connection to such user devices. The determination may include comparing operational or performance information associated with the access points, such as link quality, quality of service, current load, backhaul connectivity information, level of interference, etc., as well as pricing information associated with the access points, to determine which one or more access points exhibit performance that is relatively high as compared to other access points, or put another way, to determine which one or more access points facilitate or provide optimized wireless communications.

A determination of such access points may be implemented according to various configurations. In one configuration, a user device may receive information associated with shared access points and perform the comparison, to determine the access point that provides optimized wireless communication. The user device may also consider other information in making the determination, such as quality of service required by an application, a location of the user device, historical information associated with previous communications and locations of the user device, and various other information that will be described in greater detail below.

In certain embodiments, a cloud computing arrangement or system may also be used. The cloud computing system may receive information associated with end-to-end connectivity of the shared access points, the user devices utilizing the shared access points, historical, communications information, pricing information, etc., and leverage the information to determine one or more shared access points for optimized wireless communication. In some embodiments, the cloud computing system may collect such information and send it to the user device, where the user device may analyze the information to determine the optimized shared access point. Examples of processes performed by the cloud computing system and the user device will be described in greater detail below.

Certain embodiments herein also relate to providing a compensation system in which consumers of access points may be compensated for sharing their access points. For example, consumers may receive currency, credits, login rights, or other compensation based at least in part on an amount of utilization of their access points. Such utilization may be monitored by the cloud computing system periodically, according to a schedule, on-demand, etc.

The above descriptions are for purposes of illustration and are not meant to be limiting. Numerous other configurations, implementations, examples, etc., may exist, at least some of which are described below.

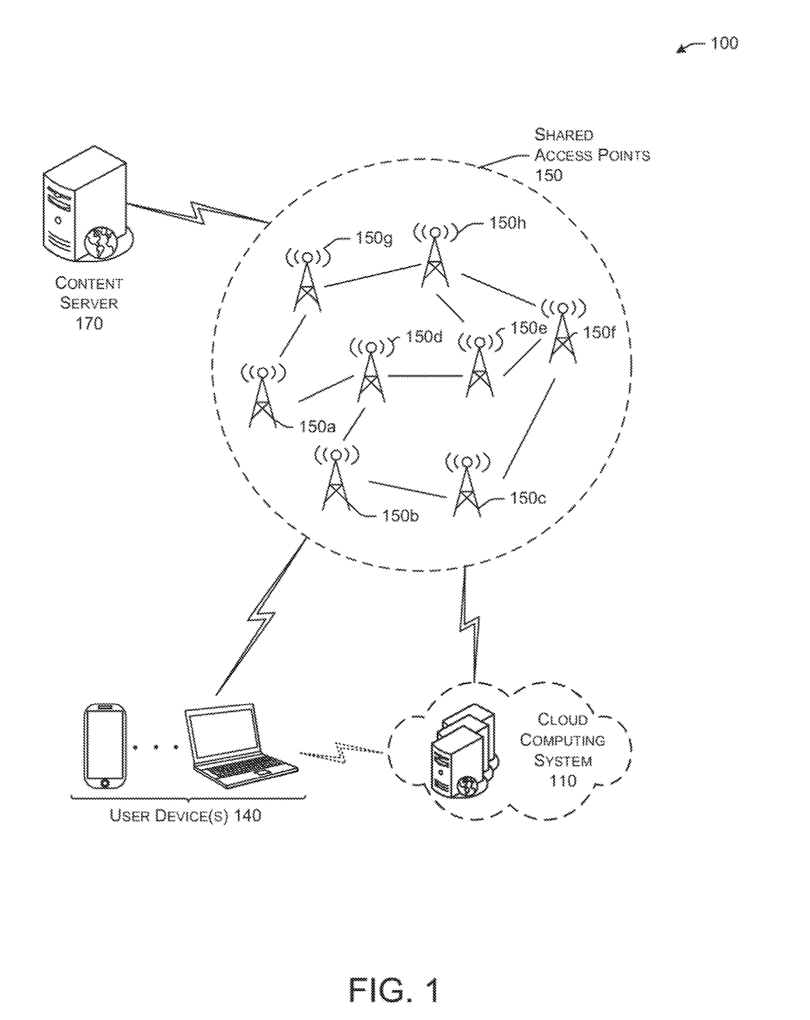

FIG. 1 depicts a schematic diagram of an example system 100 for enabling optimized wireless communication over shared wireless access points, according to an embodiment of the disclosure. The example system 100 may include, but is not limited to, a cloud computing system 110, a user device 140, a content server 170, and one or more shared wireless access points 150a-h that may form a network 150, such as a WiFi network, a WiFi Direct network, a wireless local area network (WLAN), other types of wireless networks, etc. Although a certain number of each device is shown, a different number of these devices may exist in other embodiments. The user device 140 may communicate with the content server 170 to share content, such as video, audio, text, data, multimedia, or other information over the network 150.

The one or more of the shared access points 150a-h may facilitate such communication between the user device 140 and the content server 170, as well as other devices. The shared access points 150a-h may be associated with a home, a residence, a place of business, or other facility in various locations in an area or region, such as a community, a county, a city, a state, a country, any geographical region, etc. Each wireless access point may be associated with a different location, such as a Global Positioning System (GPS) location, a street address, according to geographical coordinates, or any other unique location information. In certain embodiments herein, such wireless access points may be pooled and shared to form a network (for example, the network 150) across the various areas or regions to enable the user device 140 to access various content servers 170 in various regions.

The shared wireless access points 150a-h may be associated with consumers or end users of wireless access points, in certain embodiments. The sharing of such wireless access points 150a-h may be referred to herein as consumer shared access points, or a similar term that indicates that the shared access points 150a-h are owned, operated, controlled, or otherwise utilized by consumers of the shared access points 150a-h. Such consumers may utilize the access points 150a-h in a home, residence, or other facility in some embodiments. In other embodiments, the shared wireless access points 150a-h may be associated with persons or entities other than consumers. An example of sharing wireless access points 140a-h will be described below.

Various operational or performance information may be associated with each of the access points 150a-h. Such information may include, but is not limited to, real-time and/or historical link quality, quality of service, load levels, activity levels, etc. Examples of each of these types of information will be described in greater detail below. Such information may vary for each of the access points 150a-h and may be considered to determine one or more of the access points 150a-h to utilize for communication between the user device 140 and the content server 170.

Wireless access points 150a-h may be connected to one or more other wireless access points to facilitate communication over the network 150. For example, the access point 150a may be connected to the access points 150d and 150g, as shown. In one example, the user device 140 may access the access point 150a, followed by the access point 150b, followed by the access point 150e, and so forth, to access content associated with the content server 170 (and/or one or more other devices) as the user device 140 moves across various regions. Any number of wireless access points 150a-h may communicate with one another to form the wireless network 150 over which the user device 140 and the content server 170 may communicate.

The cloud computing system 110 may include one or more devices that may facilitate communication between the user device 140 and the content server 170, in some embodiments. Such facilitation may include analyzing information (for example, the operational and performance information described above) associated with the access points 150a-h to determine one or more wireless access points 150a-h for use by the user device 140 in communicating with the content server 170. The determination may include comparing performance information, operational information, etc., associated with wireless access points 150a-h that may be within range of the user device 140. In this way, one or more wireless access points 150a-h that meet certain criteria (for example, fastest, most reliable, etc.) may be determined and used by the user device 140 to communicate with the content server 170.

In some embodiments, the cloud computing system 110 may determine a score and/or ranking of the access points 150a-h and may subsequently send a list of the ranked wireless access points 150a-h to the user device 140, where it may be used to select an access point 150a-h for communicating with the content server 170. Such determinations may be optimized in the way that or more of the access points 150a-h that meet certain criteria better than other wireless access points 150a-h may be determined and selected, in certain embodiments herein. In other embodiments, the user device 140 may make such determinations in conjunction with, or instead of, the cloud computing system 110, as will be described in greater detail below. Hence, the cloud computing system 110 is shown with dotted lines to indicate that it is an optional system in some embodiments.

Although only one cloud computing system 110 is shown, more cloud computing systems 110 may communicate with at least a portion of the access points 150a-h and/or other wireless access points (not shown). Put another way, any number of cloud computing systems 110 may communicate with any number of wireless access points 150a-h to facilitate the processes described herein. The one or more cloud computing systems 110 may have end-to-end visibility of the access points 150a-h, including how the access points 150a-h are connected to one another and various other information.

The user device 140 may communicate with the content server 170 over the network 105, as described. To facilitate such communication, the user device 140 may receive information from the access points 150a-h and analyze the information to determine one or more of the access points 150a-h to use for communication with the content server 170, in some embodiments. In other embodiments, the user device 140 may communicate with the cloud computing system 110 to receive information associated with the access points 150a-h, a recommendation of one or more wireless access points to which to connect, or other information.

The user device 140 may also enable a user to share one or more wireless access points 150a-h in the network 150 such that they may be used by user devices 140 in range of at least one of the access points 150a-h. In one embodiment, the user device 140 may communicate with the cloud computing system 110 to facilitate such sharing. In one configuration, the cloud computing system 110 may receive a request from the user device 140 to share an access point at a user location, such as a home, residence, or other facility. The cloud computing system 110 may thereafter designate the access point as a shared access point. In some embodiments, the cloud computing system 110 may authenticate the access point prior to designating it as a shared access point.

In some embodiments, a user device 140 may perform functions associated with one or both of sharing an access point 150a-h or communicating with the content server 170 over the network 150 based on the processes described herein. For example, a separate user device 140 (not shown) may facilitate sharing of the access point 150a while a user device 140 shown in FIG. 1 may utilize the shared wireless access point 150a to communicate with the content server 170.

The above configurations in FIG. 1 are for purposes of illustration and are not meant to be limiting. Different configurations, including a different number and/or type of devices, different types of communication, etc., may exist in other embodiments.

As used herein, the term “device” may refer to any computing component that includes one or more processors that can be configured to execute computer-readable, computer-implemented, or computer-executable instructions. Example devices can include personal computers, server computers, server farms, digital assistants, smart phones, personal digital assistants, digital tablets, smart cards, wearable computing devices, Internet appliances, application-specific circuits, microcontrollers, minicomputers, transceivers, kiosks, or other processor-based devices. The execution of suitable computer-implemented instructions by one or more processors associated with various devices may form special purpose computers or other particular machines that may implement or facilitate the selection of consumer shared, access points to facilitate optimized wireless communication, as described herein.

Various types of networks 150 may facilitate communication between the devices shown in FIG. 1. Such networks may include any number of wired or wireless networks that may enable various computing devices in the example system 100 to communicate with one another. In some embodiments, other networks, intranets, or combinations of different types of networks may be used including, but not limited to, WiFi networks, WiFi Direct networks, NFC networks, Bluetooth® networks, the Internet, intranets, cable networks, cellular networks, landline-based networks, radio networks, satellite networks, other short-range, mid-range, or long-range wireless networks, or other communication mediums connecting multiple computing devices to one another.

As used herein, a “shared access point” may refer to an access point that may be accessed by a user of a user device who do not own, operate, or otherwise control the access point. The access point may nevertheless be shared by the consumer or owner of the access point such that others may utilize it to connect to a wireless network.

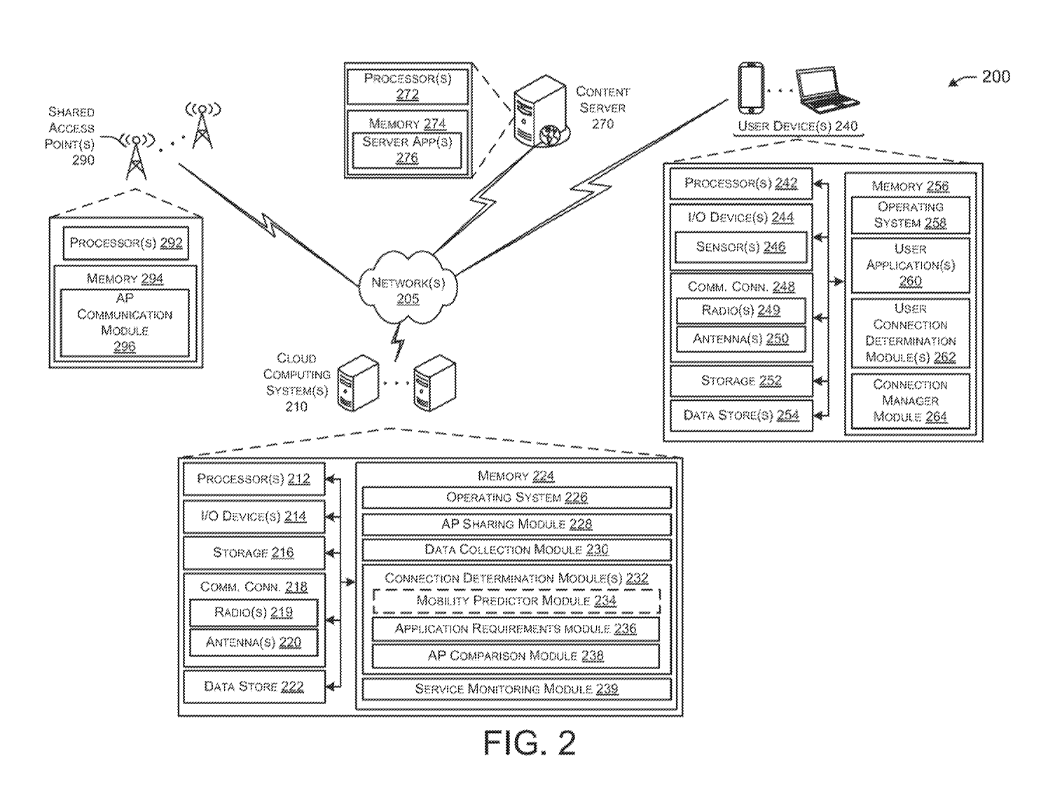

FIG. 2 illustrates an example computing environment 200 for implementing selective utilization of shared access points to facilitate optimized wireless communications, according to an embodiment of the disclosure. The example computing environment 200 may include, but is not limited to, a cloud computing system 110, a user device 240, a content server 270, and one or more shared access points 290. In one embodiment, these devices may be embodied by their corresponding devices in FIG. 1. As described above, the user device 240 may communicate with the content server 270 over one or more networks 205 via the one or more shared access points 290. The cloud computing system 110 may facilitate such communication, as will be described in greater detail below.

The devices 210, 250, 290, and access points 270 in FIG. 2 may include one or more processors configured to communicate with one or more memory devices and various other components or devices. For example, the cloud computing system 110 may include one or more devices that include one or more processors 212, one or more input/output (I/O) devices 214, storage 216, one or more communication connections 218, and one or more data stores 222. The one or more processors 212 may be implemented as appropriate in hardware, software, firmware, or a combination thereof. The one or more processors 242, 272, and 292 associated with the user device 240, the content server 270, and the access point 290 may be the same or at least similar to the processor 212, in one embodiment.

The memory 224 associated with the cloud computing system 210 may store program instructions that are loadable and executable on the processor 212, as well as data generated during the execution of these programs. Depending on the configuration and type of the cloud computing system 210, the memory 224 may be volatile, such as random access memory (RAM), static random access memory (SRAM), dynamic random access memory (DRAM); or non-volatile, such as read-only memory (ROM), Electrically Erasable Programmable Read-Only Memory (EEPROM), flash memory, etc. The memories 256, 274, and 294 associated with the user device 240, the content server 270, and the access point 290, respectively, may be the same or at least similar to the memory 224, in one embodiment.

The storage 216 associated with the cloud computing system 210 may include removable and/or non-removable storage including, but not limited to, magnetic storage, optical disks, and/or tape storage. The disk drives and their associated computer-readable media may provide non-volatile storage of computer-readable instructions, data structures, program modules, and other data for the computing system. The storage 252 associated with user device 240 and respective storage devices associated with the content server 270 and the access point 290 (not shown) may be the same or at least similar to the storage 252, in one embodiment.

The memory 224, 256, 274, 294 and the storage 216, 252, and the respective storages associated with the content server 270 and the access points 290, both removable and non-removable, are all examples of computer-readable storage media. For example, computer-readable storage media may include volatile and non-volatile, removable and non-removable media implemented in any method or technology for storage of information such as computer-readable instructions, data structures, program modules, or other data.

The I/O devices 214 associated with the cloud computing system 210 may enable a user to interact with the cloud computing system 210 to perform various functions. The I/O devices 214 may include, but are not limited to, a keyboard, a mouse, a pen, a voice input device, a touch input device, a gesture detection or capture device, a display, a camera or an imaging device, speakers, and/or a printer. The I/O devices 214 associated with the user device 240 and respective I/O devices associated with the content server 270 and the access point 290 (not shown) may be the same or at least similar to the I/O devices 244, in one embodiment.

The one or more communication connections 218 associated with the cloud computing system 210 may allow the cloud computing system 210 to communicate with other devices, such as the user devices 240 and the access points 290 via the one or more wireless networks 205. The one or more wireless networks 205 may be embodied by the one or more networks 150 in FIG. 1, in one embodiment. The communication connections 218 may include one or more antennas 220 and one or more radios 219, which may include hardware and software for sending and/or receiving wireless signals over the various types of networks 205 described above. The communication connections 248 associated with the user device 240 and respective communication connections associated with the content server 270 and the access point 290 (not shown) may be the same or similar to the communication connections 218, in one embodiment. For example, the communication connections 248 may include one or more radios 249 and antennas 250 that may enable the user device 240 to receive and/or send wireless signals to the access point 290, which may route wireless signals originating from the user device 240 to the cloud computing system 210 and/or the content server 270. The user device 240 may also communicate directly with such devices in other embodiments.

The one or more data stores 222 may store lists, arrays, databases, flat files, etc. In some implementations, the data store 222 may be stored in a memory external to the cloud computing system 210 but may be accessible via one or more networks, such as with a cloud storage service. The data store 222 may store information that may facilitate selection of one or more shared access points to facilitate optimized wireless communication, as described herein. Such information may include, but is not limited to, information associated with the operation or performance of the shared wireless access points 290 and information associated with the user device 240, among other information. Such information may be received by the cloud computing system 210, in one embodiment. All or at least a portion of the information may be stored in the data store 222, while all or at least a portion of the information may be stored in the one or more data stores 254 associated with the user device 240, another device, a remote data store, or other types of local or network-accessible data stores, in various embodiments.

Examples of information associated with the access point 290 may be related to, among other things, a link quality, such as a quality of service associated with an access point (for example, a latency, a bandwidth or throughput associated with the access point 290 and/or a backhaul connection to a content server 270, an availability or uptime (including whether an access point 290 has been blacklisted), a data error rate, jitter, etc.; a level of interference; load information, such as a number of users currently connected to the access point 290, a type of traffic being transmitted via the access point 290 (for example, bursty traffic, continuous traffic, etc.); load balancing information; end-to-end connectivity information, such as to which other wireless access points the access point 290 is connected; backhaul connectivity information, including an identification of the source of content or information accessed by the user device 240 (for example, the content server 270), a bandwidth or throughput of the backhaul connection, etc.; information that may be used to authenticate, connect to, or otherwise identify the access point 290, such as a Media Access Control (MAC) address or a corresponding basic service set identification (BSSID) or service set identifier (SSID); and pricing information associated with the access point 290, such as an amount a consumer who owns or operates the access point 290 is willing to charge other users to utilize the access point 290 for accessing the one or more networks 205.

Examples of information associated with the user device 240 may include, but is not limited to, a MAC address, IP address, or other unique information identifying the user device 240; a current location of the user device 240, such as a GPS location; an indication of whether the user device 240 is moving or stationary; personal information associated with a user, such as one or more user preferences for receiving content, displaying content, etc.; an identification of available wireless access points 290 within range of the user device 240; information associated with one or more channels available to the user device 240, such as activity levels, type of traffic, etc., associated with one or more of such channels; the signal quality received by the user device 240; and quality of service requirements associated with an application being utilized by the user device 240.

The data store 222 may include real-time and/or historical data for the above information. In this way, data may be analyzed over time to facilitate selective utilization of shared access points as described herein.

The information stored in the data store 222 may be analyzed for each wireless access point 290 to determine which wireless access point 290 to select for communicating with the content server 270, or other device. In some embodiments, the one or more data stores 254 associated with the user device 240 and a respective one or more data stores associated with the content server 270 and the access point 290 (not shown) may be the same or at least similar to the data store 222, in one embodiment. In some embodiments, the user device 240 may access all or at least a portion of the above information in the data store 254 and analyze the information to select an access point for communication with the content server 270. According to these embodiments, the user device 240 may receive at least a portion of information that may be stored in the data store 254 from the cloud computing system 210.

The above configurations are for purposes of illustration and are not meant to be limiting. Other configurations may exist in other embodiments. For example, the user device 240 may communicate with a device other than the content server 270 to obtain similar or different information. Also, different numbers and/or types of devices that may include fewer or more processors, memories, software, etc., may exist in other configurations.

Turning to the contents of the memory 224, the memory 224 may include, but is not limited to, an operating system 226, an access point sharing module 228, a data collection module 230, one or more connection determination modules 232 (for example, a mobility predictor module 234, an application requirements module 236, and an access point comparison module 238. Each of these modules may be implemented as individual modules that provide specific functionality associated with selective utilization of consumer shared access point to facilitate optimized wireless communications, as described herein. Alternatively, one or more of these modules may perform all or at least some of the functionality associated with the other modules.

The operating system 226 may refer to a collection of software that manages computer hardware resources and provides common services for computer programs to enable and facilitate operation of such programs. Example operating systems may include UNIX, Microsoft Windows, Apple OS X, etc.

The access point sharing module 228 may perform functions to implement or facilitate sharing of one or more wireless access points 290. For example, the access point sharing module 228 may receive a request to share an access point 290. The request may be received from a user utilizing the user device 240, the access point 290, or other device. The request may include various information, such as information identifying the access point 290, such as a Media Access Control (MAC) address or a corresponding basic service set identification (BSSID) or service set identifier (SSID); a location of the access point 290, such as the GPS location, a street address, etc.; bandwidth or throughput information associated with the access point 290; information associated with the consumer or owner of the access point 290, such as information identifying the consumer (for example, full name, Social Security Number (SSN) or at least a portion thereof, a user name and/or password associated with an account, etc.); and pricing information associated with the access point 290, such as an amount a consumer who owns or operates the access point 290 is willing to charge other users to utilize the access point 290.

In conjunction with receiving the request, the access point sharing module 228 may authenticate a user's access to the cloud computing system 210. Such authentication may include verifying a user's login, password, and/or other access credentials. The authentication may also include verifying that the user's account status is active and that the user is eligible for participating in sharing wireless access points for use as described herein.

After receiving the request to share the access point 290, the access point sharing module 228 may authenticate the access point 290. Such authentication may include sending a data packet to the access point 290 based at least in part on the BSSID associated with the access point 290, in one embodiment. If the data packet is successfully received by the access point 290 (as may be indicated in a response data packet received from the access point 290, in one embodiment), then authentication may be successful. If the data packet is not successfully received, then authentication may not be successful. If it is determined that the access point 290 is not within range of the cloud computing system 210, then the access point sharing module 228 may send all or at least a portion of the information received in the request to share the access point 290 to one or more other cloud computing devices 210, which may attempt to authenticate the access point 290 as described above. Various other techniques or considerations may be used to determine whether the access point 290 requested to be shared is within range, operational, or otherwise capable of being utilized by various user devices 240 to access the one or more wireless networks 205.

The access point sharing module 228 may also designate the access point 290 as shared. In so doing, the access point sharing module 228 may store information associated with the access point 290 such that the cloud computing system 210 may know to establish, track, or monitor connections, utilization, performance, other information associated with the access point 290, or otherwise may establish an indication that the access point 290 is one of shared wireless access points 290, in certain embodiments herein. The access point sharing module 228 may also send a configuration, or information associated with the configuration, to the access point 290 that may configure or facilitate configuring the access point 290 such that it may receive connections from various user devices 240. Various other functions may be performed by the access point sharing module 228, in other examples.

The data collection module 230 may perform a number of functions to facilitate the processes described herein. For example, the data collection module 230 may receive information from the access point 290 and/or the user device 240. Such information may be associated with the access point 290 and the user device 240, respectively, as described above. In addition, or as an alternative, the data collection module 230 may receive utilization information associated with the access point 290. Such information may include an identification of one or more user devices 240 that utilized the access point 290 to send and/or receive communications over the network 205, a duration of such utilization, an identification of sources of content access by the user devices 240 (for example, the content server 270), the type of content received by the user device 240 (e.g., video, audio, text, multimedia, data, etc.), etc.

The information received by the data collection module 230 may be received via a data packet transmission over the one or more networks 205, which may include a WiFi network. In some embodiments, beacon packets may be used to carry the information between the devices shown in FIG. 2. The information may be received periodically, such as every 5 seconds, 20 seconds, or any time interval); according to a schedule (for example, a recurring time of day); on-demand, such as a real-time request for the information performed by a user; upon the occurrence of an event, such as receipt of operational or performance information at the access point 290 or the user device 240; etc.

The data collection module 230 may also store received information in a data store (for example, the data store 222 or one or more other local and/or remote data stores). In this way, real-time and historical performance or other information associated with the access point 290 may be stored, identified, and used to determine an access point 290 to facilitate optimized wireless communication, as will be described in greater detail below.

The connection determination module 232 may determine one or more wireless access points 290 to which the user device 240 may connect on the network 205. In certain embodiments herein, the connection determination module 232 may determine an access point 290 that facilitates optimized wireless communication. The connection determination module 232 may include various modules to facilitate such a determination, including but not limited to an access point comparison module 238, a mobility predictor module 234, and an application requirements module 238.

The access point comparison module 238 may compare information associated with various shared wireless access points 290 to determine one or more wireless access points 290 for utilization by the user device 240. For example, all or at least a portion of the above described information associated with an access point 290 and/or the user device 240 may be compared among the various shared wireless access points 290. The comparison may be performed to determine which of the shared wireless access points 290 may provide optimized wireless communications for the user device 240. In one embodiment, certain information may be compared to make such a determination, such as bandwidths associated with wireless access points 290, latency associated with the access points 290, the loads being experienced by the access points 290, etc. Example comparisons will be described in greater detail below. In other embodiments, a score based on one or more of such criteria or information may be determined and used to determine or select an access point 290. Examples of determining such a score will be described in greater detail below.

Information used in comparisons by the access point comparison module 238 may be filtered from a larger group of information, in certain embodiments herein. For example, wireless access points 290 available in any region across cities, states, countries, or any geographical area may be shared, as described above. Such a group of wireless access points 290 may be first filtered or narrowed according to distance to the cloud computing system 210. For example, wireless access points 290 that are within range of the cloud computing system 210 may be considered in a filtered list of all shared wireless access points 290.

The shared wireless access points 290 that are within range of the cloud computing system 210 may be further filtered according to a predicted future location of the user device 240. For example, one or more access points to which the user device 240 is forecasted to be moving towards may be used in the comparison, or at least weighted relatively high in a score determination, as will be described below. In this way, a greater emphasis may be placed on shared wireless access points 290 that are more likely than others to be within range of a user device 240 that may be moving, for example, from one area to another.

The predicted future location may be determined by the mobility predictor module 236, according to one configuration. In certain embodiments, the determination may be based on information associated with the user device 240. Such information may include a current position of the user device 240 and information indicating historical locations of the user device 240. Such information may be received from the user device 240 and stored in a data store (for example, the data store 222) by the data collection module 230.

The mobility predictor module 234 may perform various functions to predict a location of the user device 240. For example, the mobility predictor module 234 may compare the current location of the user device 240 to stored locations of the same user device 240. If one or more matches are determined, then historical subsequent locations (for example, locations to which the user device 240 moved after the current location) may be analyzed to determine or predict where the user device 240 is likely to move. The locations may be geo-locations, GPS locations, or other unique locations capable of being compared to determine or predict a path of movement of the user device 240. As will be described in greater detail below, such location information may be used to determine one or more wireless access points 290 to which the user device 240 may connect for optimized wireless communications. An example of such a determination or prediction is described in greater detail below.

In some embodiments, the mobility predictor module 234 may not exist at the cloud computing system 210 but may instead exist at the user device 240, which may utilize a mobility predictor module associated with the user connection determination module 232 to perform the same or similar functions as those described above, as will be described in greater detail below.

Information associated with the shared wireless access points 290 may also be filtered based on data requirements associated with a user application in use by the user device 240. In one embodiment, the application requirements module 236 may determine a type of wireless access point 290 that it suitable for an application being utilized by the user device 240. For example, a video streaming application may require an access point 290 that has a relatively higher bandwidth than does an electronic mail application. In one embodiment, information associated with the application may be received (for example, by the data collection module 230) and analyzed by the application requirements module 236 to determine the type of wireless point 290. Such information may include a name of the application; a type or category of the application, such as gaming, audio streaming, etc.; quality of service requirements, such as an amount of bandwidth required, a reliability, availability, or uptime requirement of an access point 290, etc.); or other information that may indicate criteria or requirements for the application to operate properly.

In some embodiments, the application requirements module 236 may not exist at the cloud computing system 210 but may instead exist at the user device 240. According to these embodiments, the user device 240 may determine the requirements for an associated application and send such requirements to the cloud computing system 210, where it may be received by the data collection module 230. The cloud computing system 210 (for example, via the connection determination module 232) may utilize the requirements information, along with other information described herein, to determine an access point 290 for facilitating optimized wireless communications as described herein. In other embodiments, the user device 240 may determine the applications requirements and the one or more wireless access points 290 based on the application requirements, as will be described in greater detail below. Numerous other filters, criteria, conditions, requirements, etc., may be considered in determining a subgroup of shared wireless access points 290 for use in a comparison may exist in other examples. Other embodiments may not involve such filtering but may be based on information associated with all shared wireless access points 290 in all or at least a portion of regions in which the shared wireless access points 290 are located.

The service monitoring module 239 may perform various functions to facilitate the processes described herein. Such functions may include monitoring activities and/or statuses of devices associated with the shared wireless access points 290. In one embodiment, the service monitoring module 239 may balance loads across the various shared wireless access points 290. In one embodiment, the service monitoring module 239 may dynamically change loads associated with the access points 290. In so doing, the load service monitoring module 239 may determine a number of loads associated with each wireless access point 290, a quality of service associated with each of the access points 290 (for example, bandwidth, latency, etc.), as well as other information. The service monitoring module 239 may analyze such information to determine an appropriate load for each wireless access point 290 such that, for example, the operational performance of an access point 290 may not degrade (for example, communication slows or latency increases). For example, the service monitoring module 239 may reassign user devices 240 from an access point 290 that has a high number of user devices 240 connected to it to an access point 290 that has a fewer number of user devices 240 connected to it. In this way, the user devices 240 may be distributed amongst the available shared wireless access points 290 such that performance of all or at least a portion of the shared wireless access points 290 may be optimized.

The service monitoring 239 may also monitor the quality of service associated with the shared wireless access points 290. Such monitoring may include determining a change in the number of user devices 240 utilizing the access point 290, the number or rate of data errors, activity levels, or any other changes in system utilization or performance. Upon detecting such changes, the service monitoring module 239 may analyze information associated with the access point 290 and the user device 240, as described above. In one embodiment, the service monitoring module 239 may determine that an access point 290 different from an access point 290 currently being used by a user device 240 may be associated with better link quality or quality of service, and may subsequently recommend the different wireless access point 290.

The service monitoring module 239 may also monitor utilization of an access point 290 to determine an amount of revenue earned by the consumer of the access point 290. Such a determination may include determining a number of user devices 240 that utilized the access point 290, a duration of the utilization, and a cost per unit of time, which may be established by the consumer upon registering the shared access point 290 for sharing as described above. In one embodiment, by multiplying the duration of utilization for each user device 240 by the cost per unit of time, the revenue earned by the consumer may be determined. The service monitoring module 239 may facilitate collecting the earned revenue from each of the user devices 240 by, for example, generating billing statements and providing an interface into which users of the user devices 240 may submit currency or monetary payments owed to the consumers of the shared wireless access points 290.

In some embodiments, the consumers or owners of the access points 290 may receive credits for utilization of their wireless access points 290. In one embodiment, an account for the user may be updated to include a value of the credits, a currency, etc. The consumer may redeem credits, for example, when the consumer operates a user device 240 to access the shared wireless access points 290 to communicate over the one or more networks 205. Numerous other incentives, techniques, or mechanisms may be used to compensate consumers for utilization of their shared wireless access points 290. The service monitoring module 239 may also perform various other functions in other examples.

The above configuration for the cloud computing system 210 is for purposes of illustrations and is not meant to be limiting. Different configurations may exist in other embodiments. For example, fewer or more program modules that perform the same or different functionality may exist. Also, at least a portion of the described functionality may be provided by one or more other devices, as will be described below.

As described, a user may utilize the user device 240 to access content over the one or more networks 205. The user device 240 may include various program modules that may facilitate the processes described herein. Such program modules may include, but are not limited to, an operating system 258, one or more user applications 260, a user connection determination module 262, and a connection manager module 264.

The operating system 258 may be the same or at least similar to the operating system 226 associated with the cloud computing system 210, in one embodiment. The one or more user applications 260 may perform any number of functions, including accessing, viewing, and/or interacting with content from the content server 270. The user applications 260 may, for example, enable streaming of video, audio, data, or other information; sending and receiving electronic mail messages; etc. Another user application 260 may also include a web browser application that may enable a user of the user device 240 to view and/or interact with web-based content.

The user connection determination module 262 may perform the same or similar functions as those performed by the connection determination module 232 associated with the cloud computing system 210. For example, the user connection determination module 262 may include a mobility predictor module that may predict a future location of the user device 240, an application analysis module that may determine quality of service requirements associated with an application running on the user device 240, a data collection module that may receive information associated with the various wireless access points 290 within range of the user device 240, and an access point comparison module 238 that may compare information associated with various wireless access points 290 within range of the user device 240. Such a user connection determination module 262 may analyze the received information to determine an access point 290 that may provide optimized communications for the user device 240.

The connection manager module 264 may establish a connection between the user device 240 and an access point 290. In one embodiment such an access point 290 may be determined by the user connection determination module 262, as described above. In another embodiment, the access point 290 may be determined by the connection determination module 232 and sent to the user device 240, where the user connection manager module 264 may establish a connection based at least in part on the received information. The connection manager module 264 may identify a BSSID or unique identifier in the information and connect to the determined wireless access point 290 via the unique identifier.

The connection manager module 264 associated with the user device 240 may also monitor the quality of service associated with shared wireless access points 290 that are within range of the user device 240. As the quality of service changes, the connection manager module 264 may connect to a different wireless access point 290, for example, one that provides a better quality of service or an optimized connection in comparison with other wireless access points 290. In one embodiment, the connection manager module 264 may perform the same or similar functions as the service monitoring module 239, in one embodiment.

The content server 270 may include one or more server applications 276 that may facilitate generating and distributing content, such as video, audio, text, multimedia, data, or other information, to the user device 240. The content may be distributed via a web page using the Hypertext Markup Language (HTML), the extensible Markup Language (XML), or other markup languages or program code. The communication of content from the content server 270 may occur via the one or more shared access points 290 included in the network 205, in certain embodiments herein. In one embodiment, a server application 276 may include a web server that may receive requests for content and may subsequently generate and distribute the content to the device requesting the content.

The access point 290 may include various software and/or program modules to facilitate the processes described herein. For example, the access point 290 may include an AP (access point) communication module 296 that may configure the access point 290 to send and/or receive information from the devices shown in FIG. 1. The access points 290 may route the information between such devices to facilitate one or more of the processes described herein. The access point 290 may also include various modules to facilitate the collection and/or measurement of quality of service information, as described herein. Various other modules that configure the access points 290 to facilitate the processes described herein may also exist.

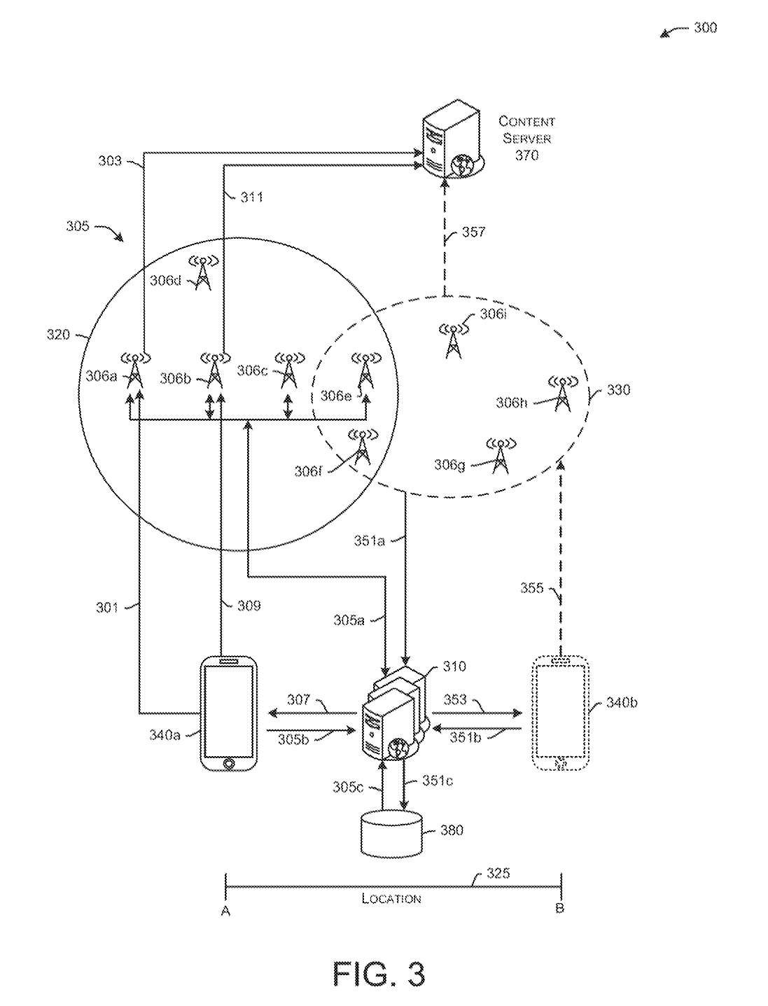

FIG. 3 depicts a block diagram of an example process for determining an access point for optimized wireless communication, according to an embodiment of the disclosure. Various shared wireless access points may exist. The shared wireless access points may be located across various regions such that at least a portion of the illustrated wireless access points may be accessible by the user devices 340a and 340b at certain locations. As shown, the user device 340a may be within range, or otherwise may have access to, the shared wireless access points 306a-f associated with the subgroup 320. As the user device 340a moves along the horizontal location axis from point A to point B (represented as the user device 340b), a different subgroup of shared wireless access points (for example, the shared wireless access points 306e-i associated with the subgroup 330) may be within range of the user device 340b. Each of the subgroups 320 and 330 may be associated with a shared wireless network, which may be a WiFi network, a WiFi Direct network, or may be embodied by the one or more networks 205 in FIG. 2, according to various embodiments. Each of the access points shown may be connected to one or more other wireless access points to facilitate communication through the access points to the content server 370, in one embodiment.

The user device 340a may communicate with the access point 306a (as shown in communication 301) to access content provided by the content server 370 (as shown in communication 303). The cloud computing system 310 may monitor link quality associated with each of the access points 306a-i (for example, via the service monitoring module 239) and may subsequently determine that the access points 306a-f are applicable to the user device 340a based at least in pan on the visibility or range of the access points 306a-f to the user device 340a. The cloud computing system 310 (for example, via the connection determination module 232) may determine whether the access point 306a enabling the current connection to the content server 370 is the optimized wireless access point based at least in part on a comparison of performance information associated with other wireless access points that are within range of the user device 340a, as will be described below.

To facilitate such a comparison, the cloud computing device 310 may receive information from the access points 306a, 306b, 306c, and 306e (for example, via the data collection module 230), as shown in communication 305a. In the present example, the cloud computing device 310 may determine that the access points 306d and 306f were blacklisted for poor performance (for example, due to a certain number of retransmissions sent as a result of data errors in packets transmitted by such wireless access points), and therefore, may not receive information from these wireless access points.

The information received from the access points may be related to a link quality, such as a quality of service associated with an access point (for example, a latency, a bandwidth or throughput associated with the access points in the subgroups 320 and 330 and/or a backhaul connection to a content server 370, an availability or uptime (including whether an access point has been blacklisted), a data error rate, jitter, etc.; a level of interference; load information, such as a number of users currently connected to the access points in the subgroups 320 and 330, a type of traffic being transmitted via the access points (for example, bursty traffic, continuous traffic, etc.); load balancing information; end-to-end connectivity information, such as to which other wireless access points the access points in the subgroups 320 and 330 are connected; backhaul connectivity information, including an identification of the source of content or information accessed by the user device 240 (for example, the content server 270); information that may be used to authenticate, connect to, or otherwise identify the access points in the subgroups 320 and 330, such as a Media Access Control (MAC) address or a corresponding basic service set identification (BSSID) or service set identifier (SSID); and pricing information associated with the access point 290, such as an amount a consumer who owns or operates the access points in the subgroups 320 and 330 is willing to charge other users to utilize the access points for accessing the one or more networks 205.

The cloud computing system 310 may also receive information from the user device 340a, as shown in communication 305b (for example, via the data collection module 230). The information received from the user device 340a may include, but is not limited to, a MAC address, IP address, or other unique information identifying the user devices 340a or 340b; a current location of the user devices 340a and 340b, such as a GPS location; an indication of whether the user devices 340a and 340b are moving or stationary; personal information associated with a user, such as one or more user preferences for receiving content, displaying content, etc.; an identification of available wireless access points within range of the user devices 340a and 340b; information associated with one or more channels available to the user devices 340a and 340b, such as activity levels, type of traffic, etc., associated with one or more of such channels; the signal quality received by the user devices 340a and 340b; and quality of service requirements associated with an application being utilized by the user devices 340a and 340b.

The cloud computing system 310 may store ah or at least a portion of the above information in the database 380 or other data store. The database 380 may include historical information associated with each of the above types of information, including movements of the user devices 340a and 340b and information associated with wireless access points 390 previously accessed by the user devices 340a and 340b. The cloud computing system 310 may access all or at least a portion of the information in the database 380 (as shown in communication 305c) and analyze it to determine an optimized wireless access point 306a, 306b, 306c, or 306e, in the present example.

In one embodiment, the cloud computing system 310 may request the received information from the access points 306a, 306b, 306c, and 306e, the user device 340a, and the database 380. In another embodiment, the information may be received from the devices and database periodically, according to a schedule, upon the occurrence of art event, etc., as described above. Upon receiving the above information, the cloud computing device 310 may compare the information for the access points 306a, 306b, 306c, and 306e to determine an optimized wireless access point, or put another way, the access point that facilitates optimized wireless communications.

According to one example, link quality information may be compared for the access points 306a, 306b, 306c, and 306e. The link quality information may include, but is not limited to, a Received Signal Strength Indication (RSSI) measurement, a Signal-to-Interference-plus-Noise Ratio (SINR), a Packet Delivery Ratio (PDR), and a Bit-Error Rate (BER). Data associated with each of these measurements, among others as indicated above, may be compared for the access points 306a, 306b, 306c, and 306e. In the present example, the access point 306a is associated with the following link quality: −30 dBm (RSSI), 28 (SINR), 88% (PDR), and 5.3% (BER), and may have 1,000 user devices currently connected to it. The access point 306b may be associated with the following link quality: −35 dBm (RSSI), 32 (SINR), 77% (PDR), and 5.1% (BER), and may have 6,000 users currently connected to it. The access point 306c may be associated with the following link quality: −45 dBm (RSSI), 5 (SINR), 100% (PDR), and 4.5% (BER), and 200 user devices connected to it. The access point 306d may be associated with the following link quality: −70 dBm (RSSI), 11 (SINR), 98% (PDR), and 3% (BER), and 7,500 user devices connected to it. Such values may not be mutually exclusive at least for the purposes of illustration. Pricing information for each of the wireless access points 306a, 306b, 306c, and 306e may also be considered in at least some embodiments.

In one embodiment, the cloud computing system 310 (for example, via the access point comparison module 238), may compare the RSSI values for each of the access points 306a, 306b, 306c, and 306e to determine which wireless access point has the optimal RSSI value. In the present example, the cloud computing system 310 may select the access point 306a because its value of −30 dBm is the best received signal strength among the access points 306a, 306b, 306c, and 306e in the comparison.

In another embodiment, the cloud computing system 310 may compare the SINR values for each of the access points 306a, 306b, 306c, and 306e to determine which wireless access point has the optimal SINR value. In the present example, the cloud computing device 310 may select the access point 306b because its value of 32 is the best SINR value among the access points 306a, 306b, 306c, and 306e in the comparison.

In another embodiment, the cloud computing system 310 may compare the PDR values for each of the access points 306a, 306b, 306c, and 306e to determine which wireless access point has the optimal PDR value. In the present example, the cloud computing device 310 may select the access point 306c because its value of 99.5% is the best PDR value among the access points 306a, 306b, 306c, and 306e in the comparison.

In another embodiment, the cloud computing system 310 may compare the BER values for each of the access points 306a, 306b, 306c, and 306e to determine which wireless access point has the optimal has the optimal BER value. In the present example, the cloud computing device 310 may select the access point 306d because its value of 3% is the best BER value among the access points 306a, 306b, 306c, and 306e in the comparison.

In another embodiment, the cloud computing device 310 may compare the number of users connected to the access points 306a, 306b, 306c, and 306e and may determine that the access point 206c should be used because it currently has the fewest number of user devices connected to it as compared to the other wireless access points in the comparison.

As described, pricing information associated with each of the access points 306a, 306b, 306c, and 306e may also be considered. In one example, the cloud computing device 310 may send pricing information associated with each access point to the user device 340a such that a user may consider pricing in a determination of which access point to select. In other examples, the cloud computing device 310 may apply a desired cost of service indicated in a user's received preferences and include such information in a determination of the optimized access point. For example, if a user prefers not to pay more than $0.05 per minute for utilization of an access point, the cloud computing device 310 may exclude access points that require payment of greater than $0.05 for utilization. Numerous other examples may exist in other embodiments.

The above example embodiments are for purposes of illustration and are not meant to be limiting. Numerous other information or data associated with any of the access points shown in FIG. 3 may be compared, alone or in combination with other information or data, to determine an access point that facilitates optimized wireless communication between the user device 340a and the content server 370. For example, historical information for each of the access points (such as that described as being stored in the database 380) may be considered in the determination of an optimized wireless access point, in some embodiment.

In some embodiments, a score may be determined for each comparison to determine the optimized wireless access point (for example, via the access point comparison module 238 in FIG. 2). In determining the score, a factor may be associated with each type of information such that certain types of information may be weighted higher than other types or information, and therefore, may have a relatively high influence on an optimization determination. According to one example, a combination of any of the RSSI, SINR, PDR, BER, and the number of connected user devices may be considered in a determination of an optimized wireless access point. For example, the SINR, PDR, and the number of devices connected may be compared to determine the optimized wireless access point of the access points 306a, 306b, 306c, and 306e. A factor of 3.5 may be assigned to the SINR, 3.0 to the PDR, and 0.2 to the number of users. In one example embodiment, the factors may be multiplied by the values for each link quality indicators and number of user devices currently connected, the result of which may be summed to obtain a score. In one embodiment, the highest score may represent the optimized wireless access point, while other criteria may be used in other embodiments. Numerous other mathematical techniques, algorithms, calculations, etc., may be used to determine a score in other examples.

In certain embodiments, the cloud computing system 310 may send information associated with the determination of art optimized wireless access point to the user device 340a, as shown in communication 307. Such information may include an identification (for example, the SSID) of the access point to which to connect for optimized wireless communications, in one embodiment. In another embodiment, the information may include a list of wireless access points to which the user device 340a may connect. The list may be ranked by score, individual criteria, etc., such that a user of the user device 340a may have knowledge of the determined performance of each of the access points in the list to facilitate selection of an access point by the user. In this way, the user device 340a may use the information received in the communication 307 to connect to an access point, for example, an optimized wireless access point as determined by the cloud computing device 310.

For purposes of illustration, it is assumed that the access point 306a is determined to be the optimized wireless access point. As shown in communication 309, the user device 340a may therefore connect to the access point 306b, which may forward communications from the user device 340a to the content server 370 and vice versa, as shown in communication 311.

In some embodiments, the user device 340a may determine the optimized wireless access point instead of, or in conjunction with, the cloud computing device 310. Such a determination may be the same or at least similar to the determinations described above in association with the cloud competing device 310. In so doing, the user device 340a may receive information associated with the access points 306a, 306b, 306c, 306e, and other wireless access points in the subgroup 320, such as the RSSI, SINR, PDR, BER, the number of connected user devices, etc., and use the information in the determination of the optimized wireless access point. In this way, the user device 340a may leverage information that may be accessible by the cloud computing system 310 but not by the user device 340a, in certain embodiments.

As the user device 340a moves along the location axis 325, one or more of a different subgroup of wireless access points may be within range of the user device 340a. In certain embodiments herein, the cloud computing system 310 may predict the movement of the user device 340a (for example, via the mobility predictor module 234 in FIG. 2). Such prediction may include accessing historical movement information associated with the user device 340a, such as an identification of wireless access points accessed historically, historical locations of the user device 340a, etc., and predicting a future location based at least in part on such information. As shown in FIG. 3, the user device 340a may reach location B (shown as user device 340b).

The same or at least similar determination of an optimized wireless access point may be made for the user device 340b. For example, the cloud computing device 310 may receive information associated with the access points in the subgroup 330, the user device 340b, and the database 380, as shown in communications 351a, 351b, and 351c, respectively. The cloud computing device 310 may analyze all or at least a portion of such information as described above to determine that the access point 306h is the optimized wireless access point, according to the present example. Information associated with the determination may be sent to the user device 340b, as shown in communication 353. Based at least in part on such information, the user device 340b may connect to the access point 306h, which may forward information from the user device 340b to the content server 370, and vice versa, as shown in communication 357.

The cloud computing system 310 (for example, via the service monitoring module 239) may monitor user activity associated with an access point to determine revenue for an owner of the access point. For example, a consumer who shared the access point 306b being utilized by the user device 340a may receive compensation (for example, revenue, credits, etc.) as a result of the user device 340a and/or other user devices utilizing the access point 306b. Such compensation may be based at least in part on an amount of time the user device 340a utilized the access point 306b, an amount of content sent through the access point 306b, or other considerations that may indicate usage of the access point 306b.

The above examples and configurations in FIG. 3 are for purposes of illustration and are not meant to be limiting. Different numbers of access points, devices, types of information, etc., may exist in other embodiments.

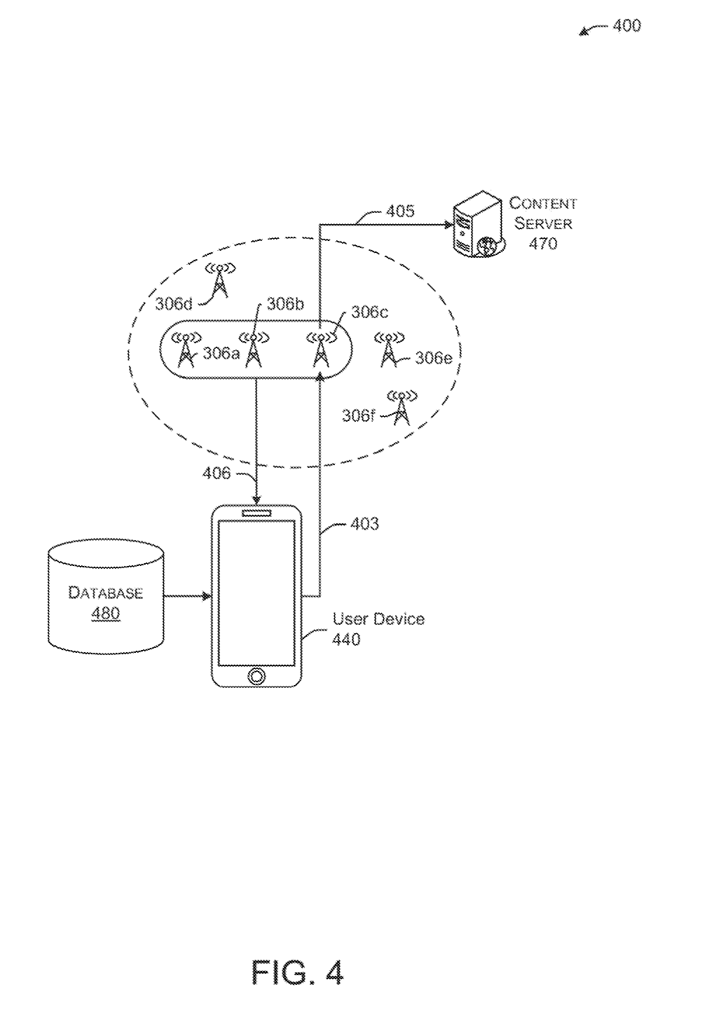

FIG. 4 illustrates a block diagram of an example process 400 for determining an access point for optimized wireless communication via a user device, according to an embodiment of the disclosure. The example process 400 may include a user device 410, a content server 470, and a subgroup 420 of shared wireless access points 306a-f. The access points 306a-f may be the same wireless access points 306a-f shown in FIG. 3, in one embodiment. The subgroup 420 may represent a smaller portion of the access points 306a-f that may be visible to the user device 440, in one embodiment. In another embodiment, the user device 440 may receive information associated with each of the access points 306a-f via various techniques. As a non-limiting example, at least one wireless access point may receive information associated with another wireless access point and forward the information to the user device 440.

In the present example, it is assumed that the user device 440 receives information associated with only the access points 306a-c, as shown in the subgroup 420. The user device 440 may receive information associated with such wireless access points and the database 480. The user device 440 may receive information associated with the various channels to which it has access, in one embodiment. The received information may be the same or at least similar to the information received in FIG. 3. The user device 440 may analyze the information (for example, via the user connection determination module 262) and determine an optimized wireless access point based at least in part on the analysis, in the same or similar fashion to that described in association with FIG. 3.

In the present example, the user device 440 may determine that the access point 306c is optimal and may subsequently establish a connection to the access point 306c, as shown in communication 403. The access point 306c may forward communications from the user device 440 to the content server 470 and vice versa, as shown in communication 405. The above example is for purposes of illustration. Numerous other examples, configurations, devices, etc., may exist in other embodiments.

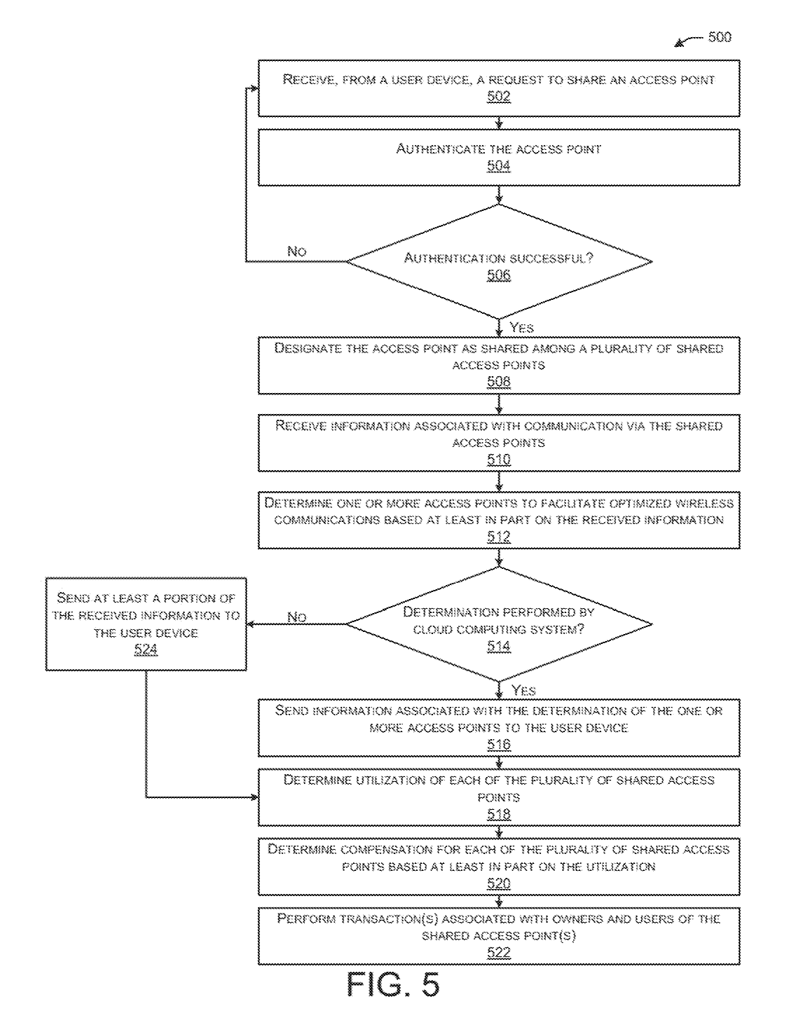

FIG. 5 depicts a flow chart of an example process for selective utilization of shared access points to facilitate optimized wireless communications via a cloud computing system, according to an embodiment of the disclosure. In one embodiment, at least a portion of the processes may be performed by the cloud computing system 210 in FIG. 2. The processing may begin at block 502, where a request to share an access point may be received from a user device (for example, via the access point sharing module 228). The access point identified in the request may be authenticated at block 504. If the authentication is successful, then the access point may be designated as shared among a plurality of multiple access points, in one embodiment. If authentication is not successful, the processing may return to block 502.

Information associated with communications over the shared access points may be received (for example, via the data collection module 230), at block 510. As described above, such information may be associated with one or more shared access points, one or more user devices, and/or one or more databases or data stores, which may store historical information associated with the user devices or access points. One or more access points to facilitate optimized wireless communications may be determined based at least in part on a comparison of the received information (for example, via the access point comparison module 238), at block 512. As described above, the determination may include comparing information associated with each shared wireless access points to determine the access point for optimized wireless communication. If the determination is performed by the cloud computing device 210, then information associated with the determination of the one or more access points may be sent to the user device (for example, via the connection determination module 232), at block 516.

If the determination is not performed by the cloud computing system 230 but is performed by the user device, then at least a portion of the received information may be sent to the user device, where the information may be processed to determine the optimized access point (for example, via the user connection determination module 262 associated with the user device 240 in FIG. 2). The portion of information may not include information associated with the user device, such as location information, performance information available to the user device upon estimating link quality associated with one or more channels accessible by the user device, etc., in one embodiment. The portion may include information associated with the shared access points, which the user device may analyze to determine the optimized shared access point.

The cloud computing system may monitor activity that occurs over the shared access points. Such monitoring may include determining utilization of each of the shared access points (for example, via the service monitoring module 239), at block 518. Compensation, such as currency, credits, etc., for each of the plurality of shared access points may be determined based at least in part on the utilization (for example, via the service monitoring module 239) at block 520, as described above. One or more transactions associated with consumers or owners, and users of the shared access points may be performed, such as crediting a consumer a certain amount of points or currency associated with one or more user devices utilizing the owner's shared access point, as non-limiting examples.

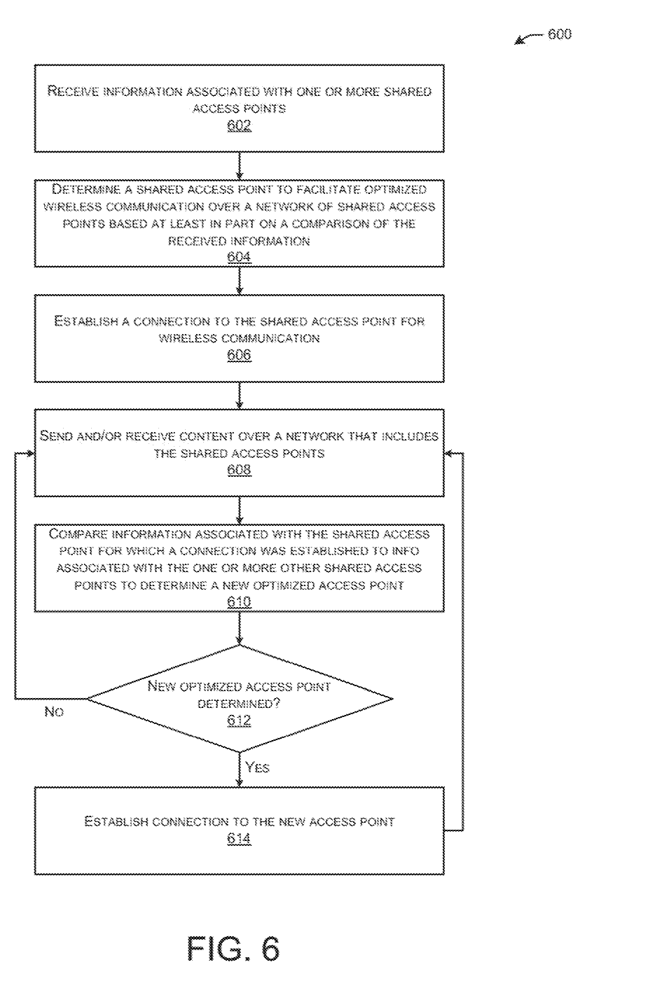

FIG. 6 depicts a flow chart of an example process for selective utilization of shared access points to facilitate optimized wireless communications via a user device, according to an embodiment of the disclosure. The example process may be performed by the user device 240, in one embodiment. The processing may begin at block 602, where information associated with one or more shared access points may be received. At least a portion of the received information may be associated with the link quality, quality of service level of interference, load, pricing, etc. At least another portion of the received information may be historical information received from a data store, such as the database 480 in FIG. 4.

A shared access point that may facilitate optimized wireless communication over a network of shared access points may be determined based at least in part on the received information, at block 604. A connection to the determined shared access point may be established (for example, via the connection manager module 264), at block 606. The user device may send and/or receive content over the network of shared access points (for example, via a user application 260), at block 608.

Activity occurring over the network of shared access points may be monitored. In one embodiment, information associated with the shared access point with which a connection was established may be compared to information associated with one or more other shared access points to determine whether a new access point now provides a more optimized wireless communication. All or at least a portion of the information associated with the access points described above may be used in the comparison. If a new optimized access point is determined at block 612, then a connection to the new access point may be established at block 614. If a new optimized access point is not determined, then processing may return to block 608, where content may continue to be received and/or sent over the network of shared access points.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks.

As an example, certain implementations may provide for a computer program product, comprising a computer-readable storage medium having a computer-readable program code or program instructions implemented therein, said computer-readable program code adapted to be executed to implement one or mote functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the contest as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

In an example embodiment, there is disclosed one or more computer-readable media storing computer-executable instructions that, when executed by at least one processor, configure the at least one processor to perform various operations. The operations may include receiving a request to share an access point for communicating information over a wireless network and associating the access point with one or more first shared access points to establish a plurality of shared access points comprising the access point. The plurality of shared access points may be located at a respective home or residence, in embodiment. The wireless network may include a WiFi network, in one embodiment.

The operations may also include receiving information associated with at least a portion of the plurality of shared access points, the information comprising data associated with a respective link quality of the at least a portion of the plurality of shared access points. The operations may further include determining one or more second shared access points based at least in part on a comparison of the received information between access points in the at least a portion, and when one or more of the second, shared access points are different from the access point, sending, to the user device, information for establishing a connection to the one or more second shared access points.

The at least one processor may be further configured to execute the computer-executable instructions to perform the operations comprising determining, based at least in part on the information, a current location of the user device, pricing information associated with the at least a portion of the plurality of access points, and a quality of service required by an application associated with the user device. The at least one processor mat also be configured to execute the computer-executable instructions to perform the operation comprising determining the one or more second shared access points based at least in part on the current location, the pricing information, and the quality of service.

In one embodiment, the determination of the one or more second shared access points further comprises comparing at least one of a Received Signal Strength Indication (RSSI) measurement, a Signal-to-Interference-plus-Noise Ratio (SINR), a Packet Delivery Ratio (PDR), a Bit-Error Rate (BER), a bandwidth, and an availability for the at least a portion of the plurality of shared access points. In one embodiment, the at least one processor may be further configured to perform the operation comprising determining a score based at least in part on the comparison.

In another example embodiment, the information associated with the user device may include a current location of the user device, and the at least one processor may be further configured to execute the computer-executable instructions to perform the operation comprising determining a future location of the user device based at least in part on the current location, one or more historical locations associated with the user device, and one or more access points previously accessed by the user device.

In another example embodiment, the at least one processor may be further configured to execute the computer-executable instructions to perform the operations comprising sending a data packet to the access point, receiving, from the access point, an acknowledgement of receipt of the data packet, and in response to receiving the acknowledgement receipt, determining that the access point is successfully authenticated and designating the access point as shared.

In another example embodiment, the at least one processor may be further configured to execute the computer-executable instructions to perform the operations comprising determining a utilization associated with the access point and a user account associated with the access point, determining an amount owed to the user based at least in part on the utilization, and updating the user account to comprise the amount.

In an example embodiment, there is disclosed a device that may include one or more radios and one or more antennas. The device configure may also include means for receiving a request to share an access point for communicating information over a wireless network and associating the access point with one or more first shared access points to establish a plurality of shared access points comprising the access point. The plurality of shared access points may be located at a respective home or residence, in embodiment. The wireless network may include a WiFi network, in one embodiment.

The device may also include means for receiving information associated with at least a portion of the plurality of shared access points, the information comprising data associated with a respective link quality of the at least a portion of the plurality of shared access points. The device may further include means for determining one or more second shared access points based at least in part on a comparison of the received information between access points in the at least a portion, and when one or more of the second shared access points are different from the access point, means for sending, to the user device, information for establishing a connection to the one or more second shared access points.

The device may further include means for determining, based at least in part on the information, a current location of the user device, pricing information associated with the at least a portion of the plurality of access points, and a quality of service required by an application associated with the user device. The device may further include means for determining the one or more second shared access points based at least in part on the current location, the pricing information, and the quality of service.

In one embodiment, the determination of the one or more second shared access points may further comprise means for comparing at least one of a Received Signal Strength Indication (RSSI) measurement, a Signal-to-Interference-plus-Noise Ratio (SINR), a Packet Delivery Ratio (PDR), a Bit-Error Rate (BER), a bandwidth, and an availability for the at least a portion of the plurality of shared access points. In one embodiment, the device may further include means for determining a score based at least in part on the comparison.

In another example embodiment, the information associated with the user device may include a current location of the user device, and the device may further include means for determining a future location of the user device based at least in part on the current location, one or more historical locations associated with the user device, and one or more access points previously accessed by the user device.

In another example embodiment, the device may further include means for sending a data packet to the access point, receiving, from, the access point, an acknowledgement of receipt of the data packet, and in response to receiving the acknowledgement receipt, means for determining that the access point is successfully authenticated and designating the access point as shared.

In another example embodiment, the device may further include means for determining a utilization associated with the access point and a user account associated with the access point, determining an amount owed to the user based at least in part on the utilization, and means for updating the user account to comprise the amount.

In an example embodiment, there is disclosed a method. The method may include receiving, by a cloud computing system comprising one or more devices, a request to share an access point for communicating information over a wireless network and associating the access point with one or more first shared access points to establish a plurality of shared access points comprising the access point. The plurality of shared access points may be located at a respective home or residence, in embodiment. The wireless network may include a WiFi network, in one embodiment.

The method may also include receiving, by the cloud computing system, information associated with at least a portion of the plurality of shared access points, the information comprising data associated with a respective link quality of the at least a portion of the plurality of shared access points. The method may further include determining, by the cloud computing system, one or more second shared access points based at least in part on a comparison of the received information between access points in the at least a portion, and when one or more of the second shared access points are different from the access point, sending, to the user device, information for establishing a connection to the one or more second shared access points.

The method may also include determining, by the cloud computing system based at least in part on the information, a current, location of the user device, pricing information associated with the at least a portion of the plurality of access points, and a quality of service requited by an application associated with the user device. The method may include determining, by the cloud computing system, the one or more second shared access points based at least in part on the current location, the pricing information, and the quality of service.

In one embodiment, the determination of the one or more second shared access points may further include comparing, by the cloud computing system, at least one of a Received Signal Strength Indication (RSSI) measurement, a Signal-to-Interference-plus-Noise Ratio (SINR), a Packet Delivery Ratio (PDR), a Bit-Error Rate (BER), a bandwidth, and an availability for the at least a portion of the plurality of shared access points. In one embodiment, the method may further include determining a score based at least in part on the comparison.

In another example embodiment, the information associated with the user device may include a current location of the user device, and the method may include determining a future location of the user device based at least in part on the current location, one or more historical locations associated with the user device, and one or more access points previously accessed by the user device.

In another example embodiment, the method may further include sending, by the cloud computing system, a data packet to the access point, receiving, from the access point, an acknowledgement of receipt of the data packet, and in response to receiving the acknowledgement receipt, determining, by the cloud computing system, that the access point is successfully authenticated and designating the access point as shared.

In another example embodiment, the method may further include determining, by the cloud computing system, a utilization associated with the access point and a user account associated with the access point, determining, by the cloud computing system, an amount owed to the user based at least in part on the utilization, and updating, by the cloud computing system, the user account to comprise the amount.

In another example embodiment, there is disclosed a method. The method may include receiving, by a user device, information associated with a plurality of shared access points. Each of the shared access points may be associated with a home or residence, in one embodiment. The method may also include determining, by the user device, a first shared access point of the plurality of shared access points based at least in part on a comparison of the information. The comparison may include at least one of a respective link quality associated with the plurality of shared access points and a quality of service associated with an application of the user device. The method may further include establishing, by the user device, a connection to the first shared access point and determining, by the user device, a second shared access point of the plurality of shared access points based at least in part on a comparison of information associated with the second shared access point to information associated with the first shared access point. The method may further include establishing, by the user device, a connection to the second shared access point.

In another example embodiment, the method may further include determining, by the user device, a current location of the user device and determining, by the user device, a future location of the user device based at least in part on at least one of previous movements of the user device or previous access points accessed by the user device. The determined second shared access point is based at least in part on the future location.

In another example embodiment, the respective link quality may include a first respective link quality, and the method may further include receiving, by the user device from a cloud computing system, information associated with a second plurality of shared access points. The determination of the second shared access point is based at least in part on the information associated with the second plurality of shared access points.

In another example embodiment, the method may further include sending, by the user device, an identification of the second shared access point and the current location of the user device to the cloud computing system.

In another example embodiment, there is disclosed a system that includes one or more radios and one or more antennas. The system may also include at least one memory that stores computer-executable instructions and at least one processor configured to access the at least one memory, wherein the at least one processor is configured to execute the computer-executable instructions to receive information associated with a plurality of shared access points. Each of the shared access points may be associated with a home or residence, in one embodiment. The at least one processor may be further configured to execute the computer-executable instructions to determine a first shared access point of the plurality of shared access points based at least in part on a comparison of the information. The comparison may include at least one of a respective link quality associated with the plurality of shared access points and a quality of service associated with an application of the user device. The at least one processor may be further configured to execute the computer-executable instructions to establish a connection to the first shared access point and determine a second shared access point of the plurality of shared access points based at least in part on a comparison of information associated with the second shared access point to information associated with the first shared access point. The at least one processor may be further configured to execute the computer-executable instructions to establish a connection to the second shared access point.

In another example embodiment, the at least one processor may be further configured to execute the computer-executable instructions to determine a current location of the user device and determine a future location of the user device based at least in part on at least one of previous movements of the user device or previous access points accessed by the user device. The determined second shared access point is based at least in part on the future location.

In another example embodiment, the respective link quality may include a first respective link quality, and the at least one processor may be further configured to execute the computer-executable instructions to receive, from a cloud computing system, information associated with a second plurality of shared access points. The determination of the second shared access point may be based at least in part on the information associated with the second plurality of shared access points.

In another example embodiment, the at least one processor may be further configured to execute the computer-executable instructions to send an identification of the second shared access point and the current location of the user device to the cloud computing system.

In another example embodiment, there is disclosed an apparatus. The apparatus may include one or more radios and one or more antennas. The apparatus may also include means for receiving information associated with a plurality of shared access points. Each of the shared access points may be associated with a home or residence, in one embodiment. The apparatus may also include means for determining a first shared access point of the plurality of shared access points based at least in part on a comparison of the information. The comparison may include at least one of a respective link quality associated with the plurality of shared access points and a quality of service associated with an application of the user device. The apparatus may further include means for establishing a connection to the first shared access point and determining, by the user device, a second shared access point of the plurality of shared access points based at least in part on a comparison of information associated with the second shared access point to information associated with the first shared access point. The apparatus may further include means for establishing a connection to the second shared access point.

In another example embodiment, the apparatus may further include means for determining a current location of the user device and means for determining a future location of the user device based at least in part on at least one of previous movements of the user device or previous access points accessed by the user device. The determined second shared access point is based at least in part on the future location.

In another example embodiment, the respective link quality may include a first respective link quality, and the apparatus may further include means for receiving, from a cloud computing system, information associated with a second plurality of shared access points. The determination of the second shared access point is based at least in part on the information associated with the second plurality of shared access paints.

In another example embodiment, the apparatus may further include means for sending an identification of the second shared access point and the current location of the user device to the cloud computing system.

1-26. (canceled)

27. One or more computer-readable media storing computer-executable instructions that, when executed by at least one processor, configure the at least one processor to perform operations comprising:
receiving a request to share an access point for communicating information over a wireless network;
associating the access point with one or more first shared access points to establish a plurality of shared access points comprising the access point;
receiving information associated with at least a portion of the plurality of shared access points, the information comprising data associated with a respective link quality of the at least a portion of the plurality of shared access points;
determining one or more second shared access points based at least in part on a comparison of the received information between access points in the at least a portion; and
when one or more of the second shared access points are different from the access point, sending, to the user device, information for establishing a connection to the one or more second shared access points.

28. The one or more computer-readable media of claim 27, the at least one processor further configured to execute the computer-executable instructions to perform the operations comprising:
determining, based at least in part on the information, a current location of the user device, pricing information associated with the at least a portion of the plurality of access points, and a quality of service required by an application associated with the user device; and
determining the one or more second shared access points based at least in part on the current location, the pricing information, and the quality of service.

29. The one or more computer-readable media of claim 28, wherein the determination of the one or more second shared access points further comprises comparing at least one of a Received Signal Strength Indication (RSSI) measurement, a Signal-to-Interference-plus-Noise Ratio (SINR), a Packet Delivery Ratio (PDR), a Bit-Error Rate (BER), a bandwidth, and an availability for the at least a portion of the plurality of shared access points.

30. The one or more computer-readable media of claim 29, the at least one processor further configured to execute the computer-executable instructions to perform the operations comprising determining a score based at least in part on the comparison.

31. The one or more computer-readable media of claim 27, wherein the plurality of shared access points are located at a respective home or residence.

32. The one or more computer-readable media of claim 27, wherein the information associated with the user device comprises a current location of the user device, and wherein the at least one processor is further configured to execute the computer-executable instructions to perform the operations comprising:
determining a future location of the user device based at least in part on the current location, one or more historical locations associated with the user device, and one or more access points previously accessed by the user device.

33. The one or more computer-readable media of claim 27, the at least one processor further configured to execute the computer-executable instructions to perform the operations comprising:
sending a data packet to the access point;
receiving, from the access point, an acknowledgement of receipt of the data packet; and
in response to receiving the acknowledgement receipt, determining that the access point is successfully authenticated; and
designating the access point as shared.

34. The one or more computer-readable media of claim 27, wherein the wireless network comprises a WiFi network.

35. The one or more computer-readable media of claim 27, the at least one processor further configured to execute the computer-executable instructions to perform the operations comprising:
determining a utilization associated with the access point and a user account associated with the access point;
determining an amount owed to the user based at least in part on the utilization; and
updating the user account to comprise the amount.

36. A method comprising:
receiving, by a user device, information associated with a plurality of shared access points, wherein each of the shared access points is associated with a home or residence;
determining, by the user device, a first shared access point of the plurality of shared access points based at least in part on a comparison of the information, wherein the comparison comprises at least one of a respective link quality associated with the plurality of shared access points and a quality of service associated with an application of the user device;
establishing, by the user device, a connection to the first shared access point;
determining, by the user device, a second shared access point of the plurality of shared access points based at least in part on a comparison of information associated with the second shared access point to information associated with the first shared access point; and
establishing, by the user device, a connection to the second shared access point.

37. The method of claim 36, further comprising:
determining, by the user device, a current location of the user device; and
determining, by the user device, a future location of the user device based at least in part on at least one of previous movements of the user device or previous access points accessed by the user device;
wherein the determined second shared access point is based at least in part on the future location.

38. The method of claim 36, wherein the respective link quality comprises a first respective link quality, the method further comprising:
receiving, by the user device from a cloud computing system, information associated with a second plurality of shared access points;
wherein the determination of the second shared access point is based at least in part on the information associated with the second plurality of shared access points.

39. The method of claim 38, further comprising sending, by the user device, an identification of the second shared access point and the current location of the user device to the cloud computing system.

40. A system comprising:
one or more radios;
one or more antennas;
at least one memory that stores computer-executable instructions; and
at least one processor configured to access the at least one memory, wherein the at least one processor is configured to execute the computer-executable instructions to:
receive information associated with a plurality of shared access points, wherein each of the shared access points is associated with a home or residence;
determine a first shared access point of the plurality of shared access points based at least in part on a comparison of the information, wherein the comparison comprises at least one of a respective link quality associated with the plurality of shared access points and a quality of service associated with an application of the user device;
establish a connection to the first shared access point;
determine a second shared access point of the plurality of shared access points based at least in part on a comparison of information associated with the second shared access point to information associated with the first shared access point; and
establish a connection to the second shared access point.

41. The system of claim 40, the at least one processor further configured to execute the computer-executable instructions to:
determine a current location of the user device; and
determine a future location of the user device based at least in part on at least one of previous movements of the user device or previous access points accessed by the user device;
wherein the determined second shared access point is based at least in part on the future location.

42. The system of claim 40, wherein the respective link quality comprises a first respective link quality, and wherein the at least one processor is further configured to execute the computer-executable instructions to:
receive, from a cloud computing system, information associated with a second plurality of shared access points;
wherein the determination of the second shared access point is based at least in part on the information associated with the second plurality of shared access points.

43. The system of claim 42, the at least one processor further configured to execute the computer-executable instructions to send an identification of the second shared access point and the current location of the user device to the cloud computing system.

44. A system comprising:
one or more radios;
one or more antennas;
at least one memory that stores computer-executable instructions; and
at least one processor configured to access the at least one memory, wherein the at least one processor is configured to execute the computer-executable instructions to:
receive a request to share an access point for communicating information over a wireless network;
associate the access point with one or more first shared access points to establish a plurality of shared access points comprising the access point;
receive information associated with at least a portion of the plurality of shared access points, the information comprising data associated with a respective link quality of the at least a portion of the plurality of shared access points;
determine one or more second shared access points based at least in part on a comparison of the received information between access points in the at least a portion; and
when one or more of the second shared access points are different from the access point, send, to the user device, information for establishing a connection to the one or more second shared access points.

45. The system of claim 44, the at least one processor further configured to execute the computer-executable instructions to:
determine, based at least in part on the information, a current location of the user device, pricing information associated with the at least a portion of the plurality of access points, and a quality of service required by an application associated with the user device; and
determine the one or more second shared access points based at least in part on the current location, the pricing information, and the quality of service.

46. The system of claim 45, wherein the determination of the one or more second shared access points further comprises comparing at least one of a Received Signal Strength Indication (RSSI) measurement, a Signal-to-Interference-plus-Noise Ratio (SINR), a Packet Delivery Ratio (PDR), a Bit-Error Rate (BER), a bandwidth, and an availability for the at least a portion of the plurality of shared access points, and wherein the at least one processor is further configured to execute the computer-executable instructions to determine a score based at least in part on the comparison.

47. The system of claim 44, the at least one processor further configured to execute the computer-executable instructions to:
send a data packet to the access point;
receive, from the access point, an acknowledgement of receipt of the data packet; and
in response to receiving the acknowledgement receipt, determine that the access point is successfully authenticated; and
designate the access point as shared.

48. The system of claim 44, the at least one processor further configured to execute the computer-executable instructions to:
determine a utilization associated with the access point and a user account associated with the access point;
determine an amount owed to the user based at least in part on the utilization; and
update the user account to comprise the amount.
